(19) United States
(12) Patent Application Publication
(10) Pub. No.: US 2016/0378155 A1
(43) Pub. Date: Dec. 29, 2016

(54) CHARGE PROCESS IN USB SETUP

(71) Applicant: Microsoft Technology Licensing, LLC, Redmond, WA (US)

(72) Inventors: Kai Allan Inha, Jarvenpaa (FI); Teemu Helenius, Riihikoski (FI)

(21) Appl. No.: 14/752,562

(22) Filed: Jun. 26, 2015

(51) Int. Cl. G06F 1/26; G06F 1/32; G06F 13/42

(52) U.S. Cl. CPC G06F 1/266; G06F 13/4282; G06F 1/3287

(57) ABSTRACT

A power delivery capability is described. In an embodiment, a device is described, comprising: a processor; and a storage comprising a set of instructions; wherein the set of instructions causes the processor to: Detect a power supplying device by universal serial bus based communication; Use a power delivery communication of the universal serial bus to read a capability of the power supplying device; Based on the capability, set a level of a power supply voltage different to universal serial bus voltages in case different voltages are supported by the power supplying device; Based on the capability, set a level of a power supply current in a linear current limiting mode in case the different voltages are not supported by the power supplying device. In other embodiments, a device and a method are discussed.

### BACKGROUND

The universal serial bus, USB, standard provides a universal interface for a computing device to connect to another device that may include universal plug-and-play and relative ease-of-use aspects. Herein, the other USB device may be referred to as a USB peripheral device as well. For example, the USB device may be a master and the peripheral device a slave. The other USB device may include power supplying devices such as chargers, power batteries, power supplies, or any other peripheral power supplying device.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

A power delivery capability is described. In an embodiment, a device is described, comprising: a processor; and a storage comprising a set of instructions; wherein the set of instructions causes the processor to: Detect a power supplying device by universal serial bus based communication; Use a power delivery communication of the universal serial bus to read a capability of the power supplying device; Based on the capability, set a level of a power supply voltage different to typical universal serial bus voltages in case different voltages are supported by the power supplying device; Based on the capability, set a level of a power supply current in a linear current limiting mode in case the different voltages are not supported by the power supplying device.

In other embodiments, a device and a method are discussed.

Many of the attendant features will be more readily appreciated as they become better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a schematic representation of a computing device which is connected to a power supplying device for power delivery between the devices according to an embodiment;

FIG. 2 illustrates a schematic representation of a computing device according to an embodiment; and

FIG. 3 illustrates a schematic flow chart of delivering power based on a detected capability of a power supplying device in accordance with an embodiment.

Like references are used to designate like parts in the accompanying drawings.

### DETAILED DESCRIPTION

The detailed description provided below in connection with the appended drawings is intended as a description of the embodiments and is not intended to represent the only forms in which the embodiment may be constructed or utilized. However, the same or equivalent functions and structures may be accomplished by different embodiments.

Although the embodiments may be described and illustrated herein as being implemented in USB Type-C and Power Delivery, PD, between USB devices, this is only an example of USB communications between computing devices and not a limitation. As those skilled in the art will appreciate, the present examples are suitable for application in a variety of different types of USB communications, for example using a USB PD mechanism. An embodiment may be a part of local connectivity between different devices. However, it is a part of a power or charge architecture as well.

The term ‘computer’, ‘computing device’, device or ‘mobile device’ is used herein to refer to any device with processing capability such that it can execute instructions. Those skilled in the art will realize that such processing capabilities are incorporated into many different devices and therefore the terms ‘computer’ and ‘computing device’ each include PCs, servers, mobile telephones (including smart phones), tablet computers, set-top boxes, media players, games consoles, personal digital assistants and many other devices.

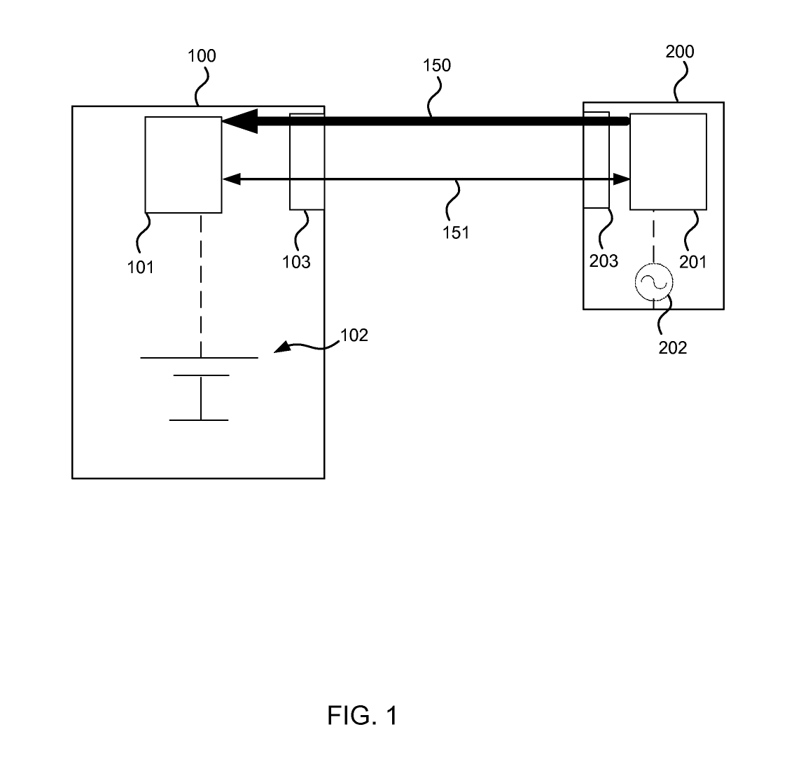

FIG. 1 illustrates a schematic representation of an embodiment, wherein a computing device 100 is connected to a power supply 200 by a USB Type-C cable 150. The computing device 100 includes a power delivery control block 101 configured to control the power delivery of the computing device 100. The power delivery control block 101 may be configured to determine a power delivery capability of the power supplying device 200, and may instruct appropriate power delivery between the computing device 100 and the power supplying device 200 based on the determined power delivery capability. The computing device 100 includes a USB interface 103 for connecting via the USB Type-C cable 150 to the power supplying device 200. The USB interface 103 is connected to the power delivery control block 101. The computing device 100 includes a battery 102. The battery is connected to the power delivery control block 101. The power supplying device 200 may be referred to as a USB peripheral device. For example, the computing device 100 is configured as a USB host (Down Facing Port, DFP) and the power supplying device 200 is configured as a USB device (Up Facing Port, UFP). The power supplying device 200 includes a USB interface 203 for connecting to the USB cable 150. The power supplying device 200 also includes a power delivery control block 201. For example, the power delivery control block 201 may be configured to determine a power delivery capability of the power supplying device 200, and be configured for power delivery between the computing device 100 and the power supplying device 200 based on the determined power delivery capability. The power supplying device 200 includes a power supply interface 202 which is configured to receive power from the power grid. A communication channel Power Delivery, PD, 151 is illustrated between the devices 100, 200. The PD 151 is used for communicating the power delivery capability information between the devices, and to instruct the devices 100,200 based on the detected capability. The PD 151 may be a part of the cable 150.

There may be a variety of different types of computing devices 100 such as a pc, lap top, portable computer, mobile device, mobile phone, tablet, phablet, etc. Likewise, the power supplying devices 200 may include peripheral devices such as chargers, power stations, power batteries, power grid points, or any other power supplying devices. In some embodiments, power supplying device 200 may be likewise another pc, lap top, portable computer, mobile device, mobile phone, tablet, phablet, configures to deliver power to a connected computing device 100.

According to an embodiment, PD 151 may be compliant with USB Type-C specifications. USB Type-C PD 151 may be used to control the power delivery parameters of the power supplying device 200, which is delivering power to a computing device 100, for example charging the device 100. The blocks 103 and 203, the cable 151 and the communication channel 151 may be compliant with USB Type-C PD. According to the USB Type-C specifications, the PD mechanism is typically used to negotiate for more current or higher voltage levels, for example deviating from the normal +5V voltage level up to +12V or +20V, in order to enable up to 100 W of charge power (20V×5 A). The normal or standardized USB Type-C charging voltages are +5V, +12V, and +20V. According to an embodiment, USB Type-C PD 151 may be used for asking for stepwise changes of voltages of the power delivery. The computing device 100 comprises the power delivery block 101 configured for controlling the power delivery accordingly. According to an embodiment, a linear, current limited charge process may be applied. By having the power delivery block 101 select an appropriate charging mode generally matching with the requirements of the computing device 100 and the capabilities of the other device 200, heat dissipation may be reduced. For example, when battery 102 is empty and current might be maximized, the power delivery block 101 along with the device 200 capabilities may be set for the charging process with reduced heat dissipation at the computing device 100.

The output voltage of the device 200 at maximum current cases may be based on V_{BATT}+V_{SWITCH}+V_{CABLE LOSS}, wherein V_{BATT} is a battery 102 voltage at a given time, V_{SWITCH} is a power delivery block 101 loss voltage, for example a transistor or FET switching loss voltage when in a fully conductive state. V_{CABLE LOSS} is cable 150 and connector loss voltage at a given time.

According to an embodiment, the power delivery control block 101 is configured to detect the power delivery capabilities of the device 200. Based on the detected capabilities, the power delivery control block 101 is configured to select a voltage mode or a current limiting mode for the power delivery. The voltage mode may be alternatively referred to as a voltage loop and the current limiting mode may be alternatively referred to as a current loop. The block 101 may perform the capability inquiry by the PD channel 151, and receive the capability by the PD channel 151.

According to an embodiment, the power delivery control block 101 is configured for the voltage mode. USB Type-C PD setup was initially designed to negotiate for voltage levels of +5V and up, with standardized levels of +5V, +12V, and +20V etc. According to an embodiment, lower than 5V voltage outputs may be negotiated between the devices 100, 200. Blocks 101, 201 are configured for PD communication 151 with a capability to negotiate voltages in, for example, some 50 mV steps in any direction, increasing or decreasing the current charging voltage. Consequently, the charging voltage of the power supplying device 200 may be stepwise changed by +/−50 mV steps. In addition, current delivery capability can also be programmed via dedicated PD commands. An embodiment does not require that the computing device 100 or the power supplying device 200 have a switching power supply. The controller block 101 may give commands to the block 201 with a capability to negotiate voltages lower than 5V. The power dissipation may be reduced at the computing device 100 end.

According to an embodiment, the power supply voltages may be different than the typical universal serial bus voltages. For example, the charging voltage of the power supplying device 200 may be stepwise changed at tens of mV level steps to a different voltage than the typical universal serial bus voltages. The devices 100,200 may support lower than the typical universal serial bus voltages, however the charging voltage may be eventually higher than, for example +5V, because of the total increased voltage by the small stepwise increases.

According to an embodiment, when the power supplying device 200 is capable of supporting a plurality of low voltage levels, in addition to programmable current levels (for example the current limiting mode), at the output, for example, lower than USB standardized voltage levels, based on the current battery voltage level, which is controlled by PD commands by the block 101, higher charge currents and reduced additional power dissipation may be achieved at both device ends 100,200. This may enable a relatively low cost and efficient charge mechanism which may be compatible with the USB Type-C architecture.

According to an embodiment, the power delivery control block 101 is configured for the current limiting mode. According to an embodiment, if the power supplying device 200 is not capable of using the voltage mode, for example the device 200 is not capable to negotiate lower than 5V levels, power delivery may continue in the current limiting mode, for example for linear current charging. According to the embodiment, lower charging current levels than the typical linear current levels are applied in order to avoid excess heat generation in the power consuming device 100. For example, even when using only low cost, low EMI linear regulation for controlling the charging current, lower charging current may be achieved, and excess heat generation in any serial, linear regulation circuitry, reduced.

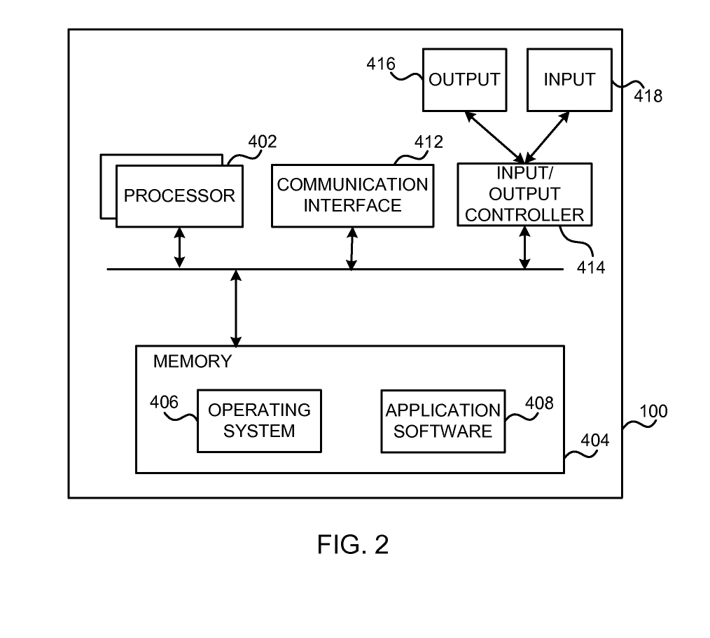

FIG. 2 illustrates an example of components of a computing device 100 which may be implemented as a form of a computing and/or electronic device. The computing device 100 comprises one or more processors 402 which may be microprocessors, controllers or any other suitable type of processors for processing computer executable instructions to control the operation of the apparatus 100. Platform software comprising an operating system 406 or any other suitable platform software may be provided on the apparatus to enable application software 408 to be executed on the device.

Computer executable instructions may be provided using any computer-readable media that are accessible by the device 100. Computer-readable media may include, for example, computer storage media such as a memory 404 and communications media. Computer storage media, such as a memory 404, include volatile and non-volatile, removable and non-removable media implemented in any method or technology for storage of information such as computer readable instructions, data structures, program modules or other data. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media do not include communication media. Therefore, a computer storage medium should not be interpreted to be a propagating signal per se. Propagated signals may be present in computer storage media, but propagated signals per se are not examples of computer storage media. Although the computer storage medium (the memory 404) is shown within the device 100, it will be appreciated that the storage may be distributed or located remotely and accessed via a network or other communication link (e.g. using a communication interface 412).

The device 100 may comprise an input/output controller 414 arranged to output information to an output device 416 which may be separate from or integral to the device 100. The input/output controller 414 may also be arranged to receive and process an input from one or more input devices 418. In one embodiment, the output device 416 may also act as the input device. The input/output controller 414 may also output data to devices other than the output device, e.g. a locally connected printing device. According to an embodiment, the power delivery control block 101, for example as shown in FIG. 1, may be established with the features of FIG. 2, for example the operating system 406 and the application software 408 working jointly, and executed by the processor 402. The USB interface may be established with the communication interface 412 for connecting to the cable 150 with the PD 151.

The functionality described herein can be performed, at least in part, by one or more hardware logic components. According to an embodiment, the computing device 100 is configured by the program code 406,408 when executed by the processor 402 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs).

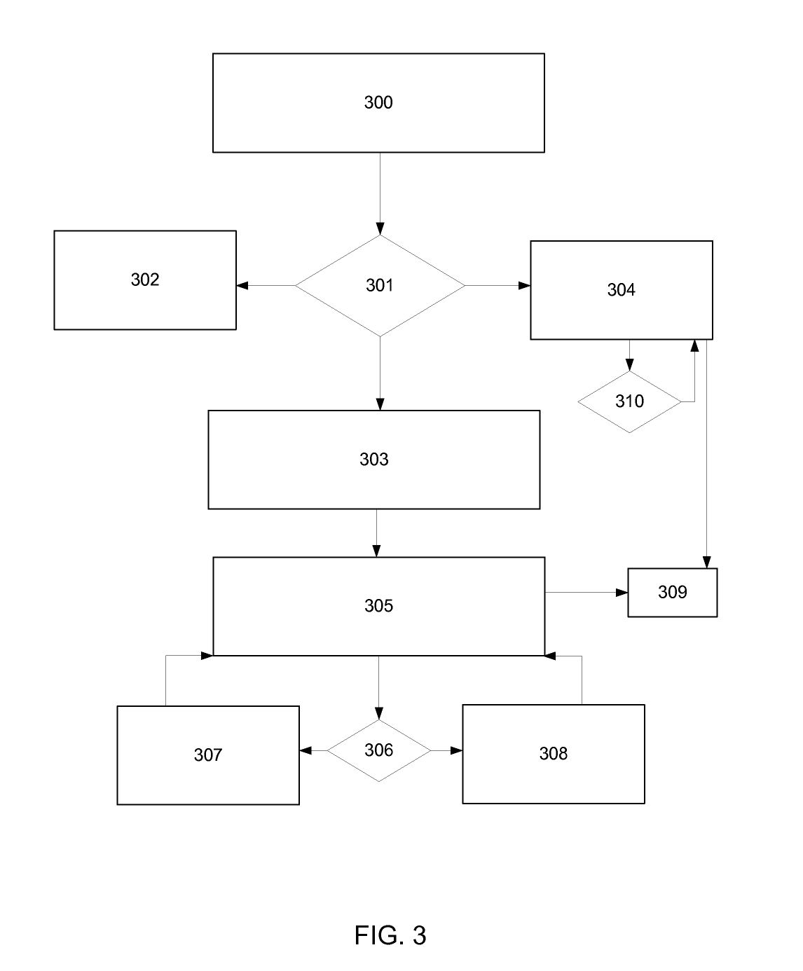

FIG. 3 illustrates, as a schematic flow chart, a method of delivering power based on a detected capability of a power supplying device 200 in accordance with an embodiment. Referring to FIG. 3, according to an embodiment the process may be utilized in the computing device 100 and the power supplying device 200 shown in FIG. 1 for power delivery based on the available capability of the devices 100,200. According to an embodiment, the process of FIG. 3 may be compiled into the program code 406,408.

Step 300 may include initiation of a USB Type-C Set Up. This may include detecting a power supplying device 200, for example detecting a charger. According to an embodiment, this may further include detecting a cable 150 of the USB Type-C. A power delivery block 101 may be configured for executing step 300. A power delivery block 201 may respond to the inquiry made by the block 101. A PD channel 151 may be used for communication.

In step 301, capability of the power supplying device 200 is read using Power Delivery, PD, according to USB Type-C specification. According to an embodiment, a mode of the power delivery, such as a mode of the charger, may be detected. The power delivery block 101 of the device 100 may be configured for executing step 300. The power delivery block 201 of the device 200 may respond with data information identifying the capability. The PD channel 151 may be used for communication.

If a capability is not detected, the power delivery device is a conventional PD capable power delivery device and the method proceeds to step 302.

If a capability is detected, the method proceeds to steps 303 or 304.

In case the capability is detected, power delivery may enter a voltage mode, which may be also referred to as the voltage loop, for example Loop V-mode, in the 303. In the voltage mode, a charging voltage is lower than a typical USB Type-C charging voltage. Typical USB Type-C values may, for example, be 5V, 12V, 20V. According to an embodiment, the charging voltage changes may be based on multitude of increments or decrements of some discrete magnitude. According to an embodiment the magnitude of the increments and decrements may be 50 mV up or down. The power delivery blocks 101 and 201 may communicate with each other via the PD 151 that the voltage mode is available.

According to an embodiment, the voltage mode may be as follows. In step 305, a setup for the voltage mode is performed. A power dissipation maximum, Pd_{MAX}, may be available or determined. For example, the blocks 101,201 may have obtained a maximum power dissipation value. A maximum voltage is calculated, for example based on the battery voltage V_{BATT} and the maximum change voltage, DV_{MAX}. A current is determined. based on Pd_{MAX} and the maximum voltage, and the required current is supplied to the battery. In step 306, new voltage values, V-values, are requested as V_{BATT} increases. According to an embodiment, voltage change steps, DV, may be approximately +/−50 mV. The goal is to minimize the power dissipation in the circuitry of device 100 during the whole charge curve, or charging phase, until the charging is done. In step 307, it is determined that the voltage is increased by a single step, for example by +50 mV. In step 308, it is determined that the voltage is decreased by a single step, for example by −50 mV. Steps 306,307,308 are continued, for example, until a threshold is reached, for example, when the charging is complete. In step 309, the power delivery process is ended, for example because the battery 102 is full. This may enable a relatively low cost and efficient charging mechanism which may be compatible with the USB Type-C architecture.

In case the capability is detected, in step 304 the power delivery may enter a current limiting mode, which may be also referred to as a current loop, for example a Loop I mode. In the current limiting mode, a charging current is limited with respect to the currently available possible charging current. The power delivery blocks 101 and 201 may communicate with each other via the PD 151 that the current mode is available. According to an embodiment, a current limit value, or an available possible current value, may be declined. Instead, the charging current may be lower than the available typical changing current. According to an embodiment, a linear regulator (not shown in the figures) of block 101 may reduce and limit the available current. The current may be dynamically reduced depending on the state of the charge of the battery 102 in step 310. When a threshold is reached, for example the battery 102 is full, the power delivery process is ended in step 309. This may enable a relatively low cost and efficient charge mechanism which may be compatible with the USB Type-C architecture.

According to an example, the computing device 100 exchanges information with the power supplying device 200 so that the computing device 100 is aware of the power delivery capabilities. The computing device 100 can decide whether a certain power delivery capability is found, and if so then use the capability with an available power delivery mode. Utilizing the power delivery capability, for example by detecting smaller available delta voltages of the charging voltage or being able to use a smaller charging current than what is available, may enable reduction of the power dissipation at the computing device 100. For example, the loss of energy which is usually lost as heat from a dynamic power delivery system may be reduced.

According to an example, the USB cable 150 may be a USB Type-C cable. The PD channel 151 may be a part of the cable 150. The USB Type-C 1.1—or any following version number after 1.1—and the PD specification 2.0—or any following version number after 2.0—define a method to allow two devices connected with a USB Type-C cable to exchange messages between them using the PD 151.

An example uses a USB Type-C cable 150 which may eventually replace the previous USB standards. With USB Type-C, the USB cable's both ends will be the same, allowing for reversible plug orientation. Users also do not need to worry about plugging it upside down. The data communication channels and wires of the USB Type-C may support the top speed of 10 Gbps or higher and may have a high power output of up to 20V (100 W) and 5A. This may improve charging of the device 100 via the USB Type-C cable 150. The USB Type-C also allows for bi-directional power, so in addition to charging the device 100, when applicable, the computing device 100 could also charge the power supplying device 200. Consequently, power swap may be possible between the primary device 100 and the peripheral device 200. According to an embodiment, the USB Type-C cable 150 provides a single tiny cable, which can be used for a variety of different devices, for both data and power connections. According to an embodiment, a USB Type-C cable 150 has a dedicated communication channel for power delivery, PD, communication 151. PD communication is used to exchange power data between two devices 100,200. The computing device 100 may initialize the communication and the device 200 may respond.

According to an embodiment, there may not necessarily be anything connected to another end of the cable plug, but the devices 100,200 may act partially independently for performing the functions and operations of the embodiments.

The methods and functionalities described herein may be performed by software in machine readable form on a tangible storage medium e.g. in the form of a computer program comprising computer program code means adapted to perform all the functions and the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store, parts or all of, an example of the process described as software. A local or terminal computer may access the remote computer and download a part or all of the software to run the program. Alternatively, the local computer may download pieces of the software as needed, or execute some software instructions at the local terminal and some at the remote computer (or computer network). Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

According to an embodiment a device, comprises: a processor; and a storage comprising a set of instructions; wherein the set of instructions causes the processor to: detect a power supplying device by a universal serial bus based communication; use a power delivery communication of the universal serial bus to read a capability of the power supplying device; based on the capability, set a level of a power supply voltage different to typical universal serial bus voltages in case different voltages are supported by the power supplying device; and based on the capability, set a level of a power supply current in a linear current limiting mode in case the different voltages are not supported by the power supplying device.

Alternatively or in addition to the above, the universal serial bus comprises universal serial bus type-c. Alternatively or in addition to the above, the power delivery of the universal serial bus type-c is used to set the level of the power supply voltage or the level of the power supply current or both. Alternatively or in addition to the above, the set of instructions further causes the processor to: set the level of the power supply voltage stepwise. Alternatively or in addition to the above, stepwise comprises tens of millivolts—level of increase or decrease with respect to a current power supply voltage. Alternatively or in addition to the above, the typical universal serial bus voltages comprise standardized universal serial bus type-c voltages having at least the levels of 5V, and optionally 12V, and 20V. Alternatively or in addition to the above, the set of instructions further causes the processor to: determine a power dissipation value of the device. Alternatively or in addition to the above, the level of the power supply voltage is set based on the power dissipation value. Alternatively or in addition to the above, the set of instructions further causes the processor to: minimize the power dissipation value by setting the level of power supply voltage. Alternatively or in addition to the above, the different power supply voltages comprises lower than typical universal serial bus voltages, and the set of instructions further causes the processor to: set the level of the power supply voltage lower than typical universal serial bus voltages in case lower voltages are supported by the power supplying device. Alternatively or in addition to the above, in the current limiting mode the set of instructions further causes the processor to: set the level of the power supply current limit to lower than a maximum defined current limit value. Alternatively or in addition to the above, the available power supply current comprises a maximum power supply current for a power output. Alternatively or in addition to the above, in the current limiting mode the set of instructions further causes the processor to: set the level of the delivered current to be lower than a maximum possible current capability of the supply. Alternatively or in addition to the above, including a linear regulator configured to set the level of the power supply current. Alternatively or in addition to the above, the set of instructions further causes the processor to: determine a power dissipation value. Alternatively or in addition to the above, the level of power supply current is set based on the power dissipation value. Alternatively or in addition to the above, the set of instructions further causes the processor to: minimize the power dissipation value by setting the level of the power supply current. Alternatively or in addition to the above, the power supplying device comprises a charger and the power supply comprises charging. Alternatively or in addition to the above, the devices are connected via a cable of the universal serial bus type-c.

According to an embodiment, a device, comprises: a processor; a storage comprising a set of instructions; and an interface; wherein the set of instructions causes the processor via the interface to: detect a power supplying device by a universal serial bus type c based communication; use a power delivery of the universal serial bus type-c to read a capability of the power supplying device; based on the capability, set a level of a power supply voltage lower than standardized universal serial bus type-c voltages in case lower voltages are supported by the power supplying device; and based on the capability, set a level of a power supply current in a linear current mode in case the lower voltages are not supported by the power supplying device. According to an embodiment, a method comprises: detecting a power supplying device by a universal serial bus based communication; using a power delivery communication of the universal serial bus to read a capability of the power supplying device; based on the capability, setting a level of a power supply voltage different to typical universal serial bus voltages in case different voltages are supported by the power supplying device; and based on the capability, setting a level of a power supply current in a linear current limiting mode in case the different voltages are not supported by the power supplying device.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A device, comprising:
a processor; and
a storage comprising a set of instructions;
wherein the set of instructions causes the processor to:
detect a power supplying device by a universal serial bus based communication;
use a power delivery communication of the universal serial bus to read a capability of the power supplying device;
based on the capability, set a level of a power supply voltage different to typical universal serial bus voltages in case different voltages are supported by the power supplying device; and
based on the capability, set a level of a power supply current in a linear current limiting mode in case the different voltages are not supported by the power supplying device.

2. The device of claim 1, wherein the universal serial bus comprises universal serial bus type-c.

3. The device of claim 1, wherein the power delivery of the universal serial bus type-c is used to set the level of the power supply voltage or the level of the power supply current or both.

4. The device of claim 1, wherein the set of instructions further causes the processor to: set the level of the power supply voltage stepwise.

5. The device of claim 4, wherein stepwise comprises tens of millivolts—level of increase or decrease with respect to a current power supply voltage.

5. The device of claim 1, wherein the typical universal serial bus voltages comprise standardized universal serial bus type-c voltages having at least the levels of 5V, and optionally 12V, and 20V.

6. The device of claim 1, wherein the set of instructions further causes the processor to: determine a power dissipation value of the device.

7. The device of claim 6, wherein the level of the power supply voltage is set based on the power dissipation value.

8. The device of claim 7, wherein the set of instructions further causes the processor to: minimize the power dissipation value by setting the level of power supply voltage.

9. The device of claim 1, wherein the different power supply voltages comprises lower than typical universal serial bus voltages, and the set of instructions further causes the processor to: set the level of the power supply voltage lower than typical universal serial bus voltages in case lower voltages are supported by the power supplying device.

10. The device of claim 1, wherein in the current limiting mode the set of instructions further causes the processor to: set the level of the power supply current limit to lower than a maximum defined current limit value.

11. The device of claim 10, wherein the available power supply current comprises a maximum power supply current for a power output.

12. The device of claim 1, wherein in the current limiting mode the set of instructions further causes the processor to: set the level of the delivered current to be lower than a maximum possible current capability of the supply.

13. The device of claim 1, including a linear regulator configured to set the level of the power supply current.

14. The device of claim 1, wherein the set of instructions further causes the processor to: determine a power dissipation value.

15. The device of claim 14, wherein the level of power supply current is set based on the power dissipation value.

16. The device of claim 15, wherein the set of instructions further causes the processor to: minimize the power dissipation value by setting the level of the power supply current.

17. The device of claim 1, wherein the power supplying device comprises a charger and the power supply comprises charging.

18. The device of claim 1, wherein the devices are connected via a cable of the universal serial bus type-c.

19. A device, comprising:
a processor;
a storage comprising a set of instructions; and
an interface;
wherein the set of instructions causes the processor via the interface to:
detect a power supplying device by a universal serial bus type-c based communication;
use a power delivery of the universal serial bus type-c to read a capability of the power supplying device;
based on the capability, set a level of a power supply voltage lower than standardized universal serial bus type-c voltages in case lower voltages are supported by the power supplying device; and
based on the capability, set a level of a power supply current in a linear current mode in case the lower voltages are not supported by the power supplying device.

20. A method, comprising:
detecting a power supplying device by a universal serial bus based communication;
using a power delivery communication of the universal serial bus to read a capability of the power supplying device;
based on the capability, setting a level of a power supply voltage different to typical universal serial bus voltages in case different voltages are supported by the power supplying device; and
based on the capability, setting a level of a power supply current in a linear current limiting mode in case the different voltages are not supported by the power supplying device.
